(19) United States
(12) Patent Application Publication
(10) Pub. No.: US 2003/0197045 A1
(43) Pub. Date: Oct. 23, 2003

(54) Power stapler

(76) Inventor: Zhen Yu Luo, Fu Cheng (CN)

Correspondence Address: ORUM & ROTH, 53 W. JACKSON BLVD, CHICAGO, IL, 60604, US

(21) Appl. No.: 10/125,722

(22) Filed: Apr. 17, 2002

(51) Int. Cl. B27F 7/23

(52) U.S. Cl. 227/2; 227/131

(57) ABSTRACT

An electrically powered stapler has inner side walls incorporating a staple carrier for feeding a cartridge of staplers towards a stapling station where one of the staples in the cartridge is positioned for being driven by an electric motor through a number of sheets held in the station. The stapler includes a staple carrier-release button for mechanically releasing the staple carrier from an in-use stapling position (for the purpose of refilling the staple carrier with a staple cartridge). An electrical disable switch is associated is with the staple carrier to disable the motor if the staple carrier is not in the in-use stapling position.

### BACKGROUND OF THE INVENTION

The invention relates to staplers and particularly to power staplers that do not require manual operation.

Staplers are commonly used in offices and homes for stapling together sheets of paper, but may be used for stapling together other items such as textile pieces and the like. In each case the ‘sheets’ are placed on an anvil and a stapler is pressed closed. This typically presses out a staple from a remote end of a cartridge of staples and through the sheets on the anvil, and closes the staple to attach the sheets together. Such staplers are often manually operated.

Electrically powered staplers have been proposed in U.S. Pat. Nos. 6,068,173 and 5,222,645. These patents essentially show the mechanism of a manual stapler construction that is mechanised by using force generated by an electric battery-operated motor mounted inside the stapler. Thus, mechanical limitations associated with manual staplers are not overcome although such ‘power staplers’ provide some inherent improvements and convenience by making the stapling operation at least semi-automatic.

An improved electrical stapler is disclosed in the present applicant's co-pending European patent application number 01305752.6. It would be desirable to improve the functionality of the stapler disclosed in that application by providing a special switching set-up to prevent actuation of the stapler when the staple carrier is not fully home in the use-position.

### OBJECTS OF THE INVENTION

It is an object of the invention provide a powered stapler that overcomes or at least reduces these problems and/or provides improved functionality.

### SUMMARY OF THE INVENTION

There is disclosed herein an electrically powered stapler having a inner side walls incorporating a stapler carrier for feeding a cartridge of staples towards a stapling station where one of the staples in the cartridge is positioned for being driven by an electric motor through a number of sheets held in the station above a horizontal anvil, the stapler including a staple carrier-release button for mechanically releasing the staple carrier from an in-use stapling position (for the purpose of refilling the staple carrier with a staple cartridge), the stapler further comprising an electrical disable switch associated with the staple carrier to disable the motor if the staple carrier is not in the in-use stapling position.

Preferably, a staple trigger-switch is provided near the anvil to close a circuit to the electric motor.

Preferably the disable-switch is in circuit with the trigger-switch.

Preferably the staple carrier-release button has associated with it a mechanism pressing against a back end of the staple carrier.

Preferably the staple carrier is mounted pivotally to the housing.

Typically, a punch plate is supported for sliding movement above the anvil in substantially perpendicular relationship to the anvil.

Typically, an elongate intermediately pivoted lever having one end arranged to press down and lift up the punch plate to carry out stapling operations.

Typically, a gear has a crank that pushes the lever to move the other end of the lever up and down as the gear rotates.

Preferably, the electric motor is coupled to intermittently drive the gear through single revolution or some other predefined angular movement for each stapling operation.

The lever preferably has an elongate closed channel to receive the crank such that the crank can slide backwards and forwards along the channel as the gear rotates to move the lever up and down during each stapling operation.

The channel is preferably non-uniformly or asymmetrically disposed about the longitudinal axis of the elongated lever such that the cutting blade is moved up and down at different linear motion rates relative to a constant rotational speed of the gear.

A staple extractor tool may be provided that is mounted for sliding movement to a base of the housing and is arranged to be manually moved and exposed at one end of the housing when required for use.

In some forms of the invention the apparatus is battery powered.

### BRIEF DESCRIPTION OF THE DRAWINGS

A preferred from of the invention will now be described with reference to the accompanying drawings, in which:

FIG. 1 is an exploded isometric view of a stapler;

FIG. 2 is an interior isometric view of the mechanism of the stapler of FIG. 1;

FIG. 3 is a side elevational view of the mechanism shown in FIG. 2;

FIG. 4 is a diagrammatic side view of mechanical components of the stapler showing the lever and punch plate in a first position;

FIG. 5 is a diagrammatic side view of the basic components of the stapler showing the lever and punch plate in a second position; and

FIG. 6 is an isometric view of a stapling adjustment carriage of the stapler;

FIG. 7 is a plan view of the carriage of FIG. 6;

FIG. 8 is a side view of the carriage of FIG. 6;

FIGS. 9, 10, 11 and 12 are side views of the staple carrier and release switch in different positions, and

FIG. 13 is a schematic elevational view of internal components of the stapler.

### DESCRIPTION OF THE PREFERRED EMBODIMENT

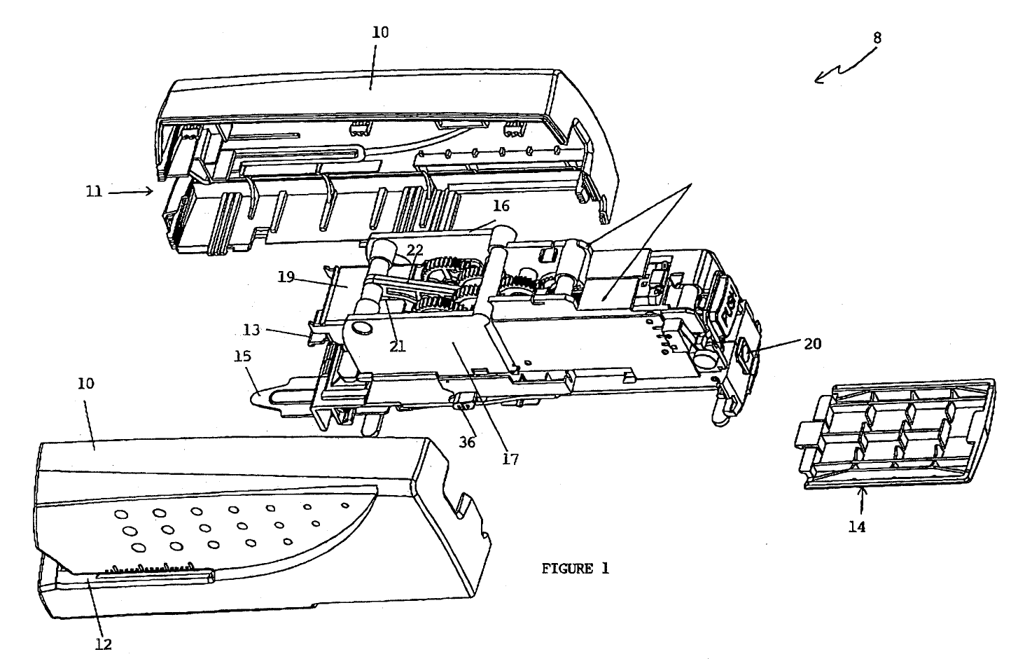

Referring to the Figures, there is shown a power stapler having an outer housing 10 which defines a slot 11 for receiving edges of sheets of paper (not shown) to be stapled together. The power stapler B includes a stapling station having a horizontal anvil 12 and elongated staple carrier 13 for holding a staple cartridge. The staple carrier 13 is mounted for sliding axial movement out of the housing 10 when it is necessary to replace the staple cartridge. A removable battery compartment cover 14 provides access to replace batteries in the compartment that extends within the base of the housing 10. A recharging/power socket 20 is provided to power the stapler and/or recharge its batteries. A staple removal tool 15 is mounted for sliding movement in or under the base 10 and is mounted to allow manual movement from a position on or under the base 10 to an extended position, as shown in FIG. 1 when required for use.

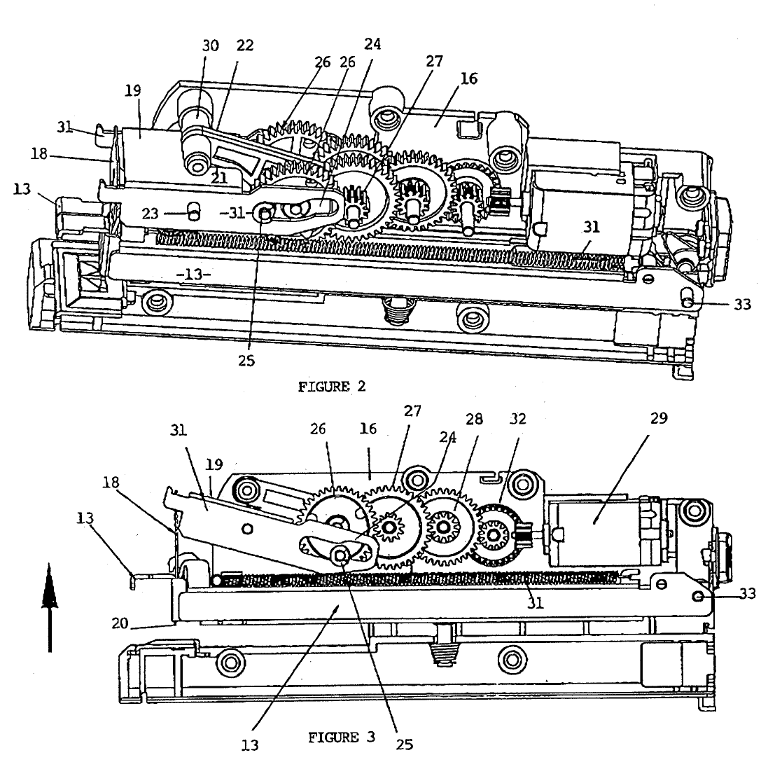

There are two moulded inner side-walls 16 and 17 that fit into the housing 10 for supporting and containing components of the stapler described below. A punch blade or punch plate 18 is carried by a support 19. The punch blade 18 with the support 19 is arranged to slide vertically The support 19 has a central aperture 21 for receiving an end of an elongate arm 22 that is best seen in FIG. 2. The arm 22 is mounted between each side-wall 16, 17 at position 30 as shown in FIG. 2. Arm 22 serves as a mounting frame for the gears.

At each side of the arm 22 there is a lever 31. Each lever 31 has a pivot axle 23 and an elongated closed channel 24 for receiving a crank pin 25. The crank pin is mounted on the side of a gear 26, which is rotatable in a vertical plane. Intermediate gears 27, 28 and 32 connect the gear 26 to an electric drive motor 29.

FIGS. 2 to 5 also show the staple carrier 13 and a spring 31 for biasing staples (not shown) in the staple carrier 13 towards the stapling station. The staple carrier 13 is mounted pivotally at 33 between the sidewalls.

In general, the well-known stapling operation comprises pressing one staple in the staple carrier 13 downwardly through sheets of paper placed in the stapling station (i.e. in the slot 11) and against the anvil 12 to close the staple. Commonly, stapling operations are performed manually but in the preferred embodiment of the invention, stapling operations are carried out by using a contact spring electric switch 34 to turn ON the motor 29 to rotate the gear 26 one complete revolution. The switch is automatically operated when the sheets are pushed fully into the slot 11. The switch 34 is mounted on an adjustment carriage 35 that is movable by pushing tab 36 so as to set how far min from the edge of the sheets the staple is to be inserted. The adjustment carriage provides a buffer surface 37 against which the edges of the paper bear to define this offset.

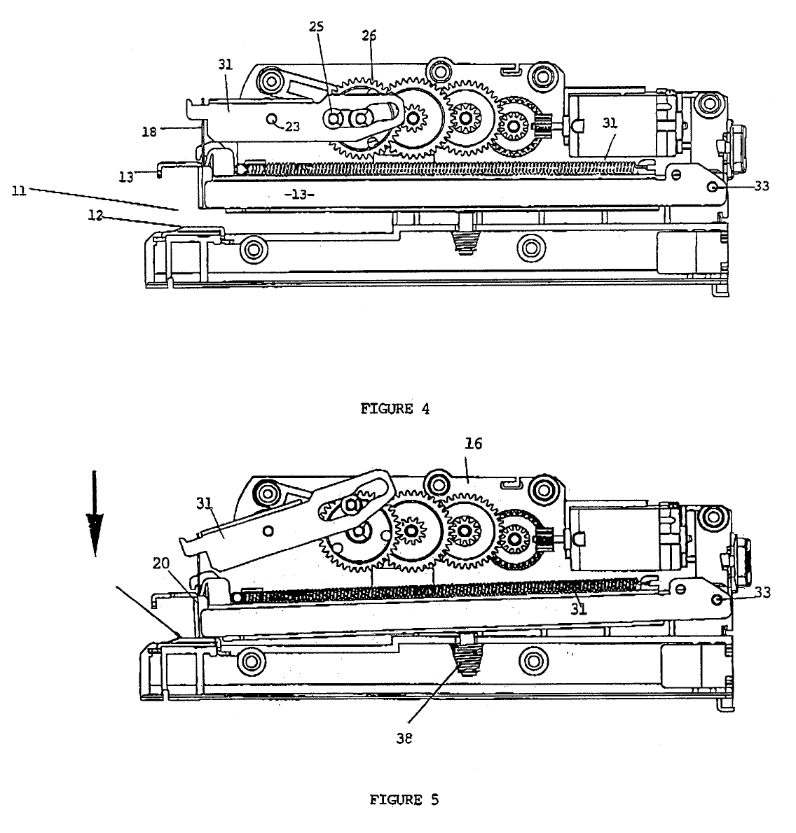

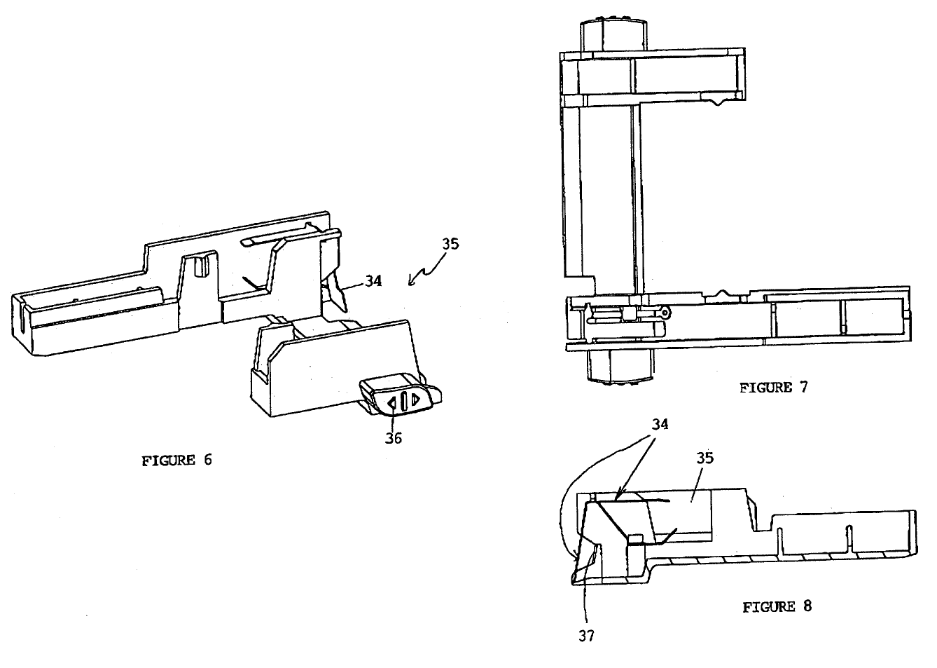

FIGS. 3, 4 and 5 show three sequential positions of the punch blade 18. In FIG. 3, the stapler is “at rest” with the punch blade 18 at its highest position. When sheets of paper are placed fully into the slot 11, the motor 29 is momentarily turned on and off to cause the gear 26 to rotate 360 degrees. The staple carrier 13 moves to its lowest position first due to its interaction with a coil spring 38 as shown in FIG. 5. FIGS. 3, 4 and 5 illustrate the respective positions of the levers 31 and the support 19 throughout approximately the first 175 degrees of movement. As illustrated by FIGS. 3, 4 and 5, the clockwise motion of the gear 26 and the crank 25 associated therewith that engages the slot 24 of the lever 31, causes pivotal movement the levers 31 to cause the punch blade 18 to move downwards. The punch blade 18 has a repetitious cyclical operation of any down-stroke and an upstroke. FIG. 4 shows the punch blade 18 halfway down in the down-stroke as the punch blade 18 moves towards the anvil 12. FIG. 5 shows the punch blade 18 at its lowest position during a stapling operation. In the described embodiment, the gear 26 continues to turn clockwise, and although it has not quite completed a half of a revolution in FIG. 5, the punch blade 18 is not pushed any further down. This is because the slot 24 is non-uniformly disposed about a longitudinal axis. In other words, the slot 24 is asymmetrically disposed with respect to a longitudinal axis of the levers 31. Accordingly, the punch blade 18 is not moved at a uniform rate up and down even if the gear 26 has a constant rotational speed. Thus, the non-uniformity of the slot 24 causes the punch blade 18 to slow down or stop moving just before the gear 26 and the crank pin 25 reaches the upper most physically possible position.

The stapling cycle is completed when the gear 26 continues clockwise from the position shown in FIG. 5 to the position shown in FIG. 3. The end of Lever 31 touches the swing Lever 42 as shown in FIG. 13. The swing Lever 42 rotates about pivot axis 43 and touches the nearby leaf switch 44. This cuts off the circuit and the stapling cycle is completed. It enabling the stapled-together sheets (not shown) to be readily withdrawn from the slot 11. Advantageously, the punch blade carrier 19 is constrained to move down vertically by the grooves 20. This movement is independent of the varying direction of forces applied by the end of the levers 31. In other words, only the vertical component of the force applied by the end of the lever 22 is utilised to move the punch blade carrier 19 within the slots 20. In at least some prior art structures isolation of the vertical force component is to achieved or is difficult to maintain. Because the vertical force component is not isolated, malfunctioning often occurs.

During the downward movement of blade 18 by action of levers 31, the staple carrier 13 pivots downwardly about pivot axis 32 to thereby close the slot 11.

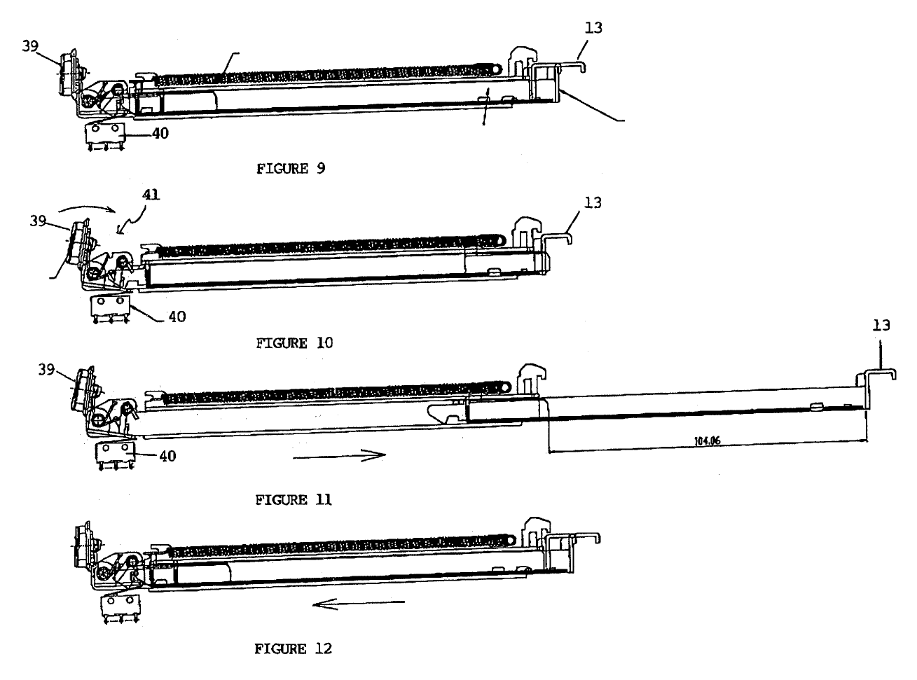

Referring now to FIGS. 9 to 12, there is shown a special press-button 39 that is used to release the staple carrier 13 and also activate a switch 40 to put motor 29 out of circuit.

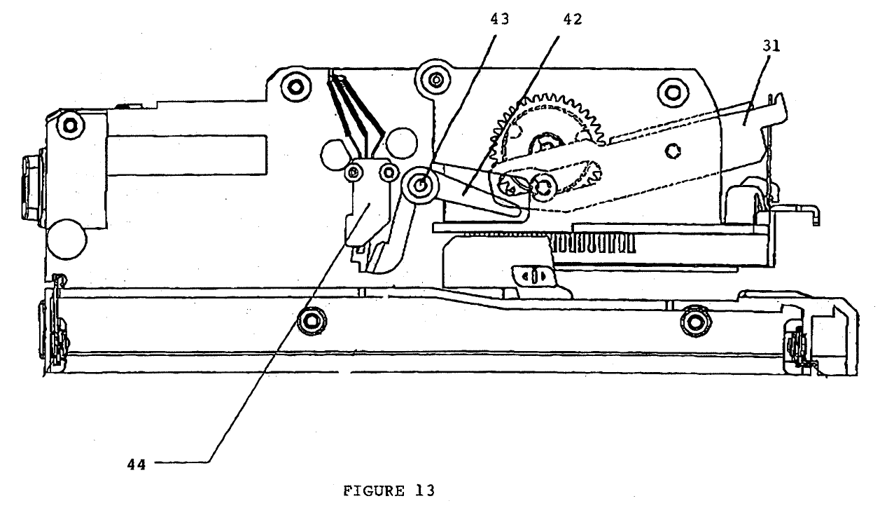

When the button 39 is depressed, it's associated mechanism 41 presses against the back end of staple carrier 13 to enable it to be manually withdrawn for the purpose of replacing a stable cartridge. In the withdrawn position as depicted in FIG. 11, the press button 39 stays down by action of the mechanism 41 to thereby maintain the FIG. 10 and FIG. 11-position of the switch 40. When the staple carrier 13 is push manually back into its rest or home-position as shown in FIG. 9, the mechanism 41 pushes the push button 39 back and releases pressure from switch 40 to thereby put the electric motor 29 back in circuit for use. This is a safety feature to prevent activation of the blade 18 when the staple carrier 13 is released for staple refilling.

It should be appreciated that modifications and alterations obvious to those skilled in the art are not to be considered as beyond the scope of the present invention. For example, a mechanism different to that identified at numeral 41 in FIG. 10 could be adopted. Furthermore, a paper edge-sensing switched different to the specific arrangement depicted in FIG. 8 could be adopted.

1. An electrically powered stapler having inner side walls incorporating a staple carrier for feeding a cartridge of staples towards a stapling station where one of the staples in the cartridge is positioned for being driven by an electric motor through a number of sheets held in the station above a horizontal anvil, the stapler including a staple carrier-release button for mechanically releasing the staple carrier from an in-use stapling position, the stapler further comprising an electrical disable switch associated with the staple carrier to disable the motor if the staple carrier is not in the in-use stapling position.

2. The stapler of claim 1 wherein a staple trigger-switch is provided near the anvil to close a circuit to the electric motor.

3. The stapler of claim 2, wherein the disable-switch is in circuit with the trigger-switch.

4. The stapler of claim 1, wherein the staple carrier-release button has associated with it a mechanism pressing against a back end of the staple carrier.

5. The stapler of claim 1, for the comprising a punch plate that is supported for sliding movement above the anvil in substantially perpendicular relationship to the anvil.

6. The stapler of claim 5, further comprising an elongate intermediately pivoted lever having one end arranged to press down and lift up the punch plate to carry out stapling operations.

7. The stapler of claim 6, further comprising a gear having a crank that pushes the lever to move the other end of the lever up and down as the gear rotates.

8. The stapler of claim 7, wherein the electric motor is coupled to intermittently drive the gear through single revolution or some other predefined angular movement for each stapling operation.

9. The stapler of claim 6, wherein the lever has an elongate closed channel to receive the crank such that the crank can slide backwards and forwards along the channel as the gear rotates to move the lever up and down during each stapling operation.

10. The stapler of claim 9, wherein the channel is non-uniformly or asymmetrically disposed about the longitudinal axis of the elongated lever such that the cutting blade is moved up and down at different linear motion rates relative to a constant rotational speed of the gear.

11. The stapler of claim 1, further comprising a staple extractor tool mounted for sliding movement to a base of the housing and arranged to be manually moved and exposed at one end of the housing when required for use.

12. The stapler of claim 1, further being battery-powered.

13. The stapler of claim 1, wherein the staple carrier is mounted pivotally to the inner side walls.
